(19) United States
(12) Patent Application Publication
(10) Pub. No.: US 2014/0102964 A1
(43) Pub. Date: Apr. 17, 2014

(54) MACHINE TOOL EQUIPPED WITH CUTTING FLUID FILTERING DEVICE

(71) Applicant: FANUC CORPORATION, Minamitsuru-gun (JP)

(72) Inventor: Mitsuyoshi ISHIHARA, Minamitsuru-gun (JP)

(73) Assignee: FANUC CORPORATION, Minamitsuru-gun (JP)

(21) Appl. No.: 14/054,756

(22) Filed: Oct. 15, 2013

(30) Foreign Application Priority Data
Oct. 15, 2012 (JP) 2012-228335

(51) Int. Cl. B01D 29/66; B01D 35/02

(52) U.S. Cl. CPC B01D 29/668; B01D 29/661; B01D 35/02
USPC 210/108; 210/140

(57) ABSTRACT

A filter which is used to remove chips and sludge produced by the processing using a machine tool is backwashed. At this time, a valve provided in an outlet of a filter container is opened based on an elapse time from the start of the supply of compressed air or a cutting fluid to the filter container or a detection value of a pressure inside the filter container. In this way, the supply pressure of the cutting fluid or the compressed air is sufficiently applied to the filter, so that chips adhering to a surface of the filter are sufficiently removed.

### BACKGROUND OF THE INVENTION

1. Field of the Invention

The present invention relates to a machine tool equipped with a cutting fluid filtering device having a filter washing function of backwashing a filter used to remove chips and sludge mixed with a cutting fluid in the processing using a machine tool.

2. Description of the Related Art

Impurities such as chips and sludge produced by the processing using a machine tool are mixed with a cutting fluid, and adversely affect the performance and the reliability of the machine tool. For this reason, a filter is used to remove the impurities. Then, in order to keep the purification performance of the filter and extend the lifetime thereof, the filter is washed. When washing the filter, an operation is performed in which the cutting fluid is caused to flow in a direction opposite to the flow direction of the cutting fluid which is used for the normal purpose so that chips and sludge adhering to the filter are removed from the filter.

The backwashing operation is generally known in Japanese Patent Application Laid-Open Nos. 2006-272474, 2006-255833, and 2001-252847, and the backwashing operation will be schematically described by referring to FIG. 8.

First, inlet side and outlet side pipe lines 121 and 122 of a filter container 113 and a filter to be backwashed are closed so that a cutting fluid remaining in the filter and the filter container 113 may not move. Subsequently, compressed air is supplied into the filter in a direction opposite to the cutting fluid flow direction in which the cutting fluid flows for the normal purpose and a discharge valve 115 of a discharge pipe line 123 connected to the filter container 113 is opened, so that the cutting fluid pressurized by the compressed air passes through the filter and flows to the discharge pipe line 123 through the opened discharge valve 115. Accordingly, impurities such as chips and sludge adhering to the filter are removed by the flow of the cutting fluid.

In FIG. 8, Reference Numeral 110 indicates a machining fluid tank, Reference Numeral 111 indicates a filter pump, Reference Numeral 112 indicates an inlet side valve provided in the inlet side pipe line 121, Reference Numeral 118 indicates an outlet side valve provided in the outlet side pipe line 122, Reference Numeral 113 indicates a filter container, Reference Numeral 114 indicates a differential pressure switch, Reference Numeral 116 indicates an air source, Reference Numeral 117 indicates an air supply valve, Reference Numeral 119 indicates a cutting fluid including chips and stored in the machining fluid tank 110, and Reference Numeral 120 indicates a pipe line. Furthermore, Reference Numeral 170 indicates a machine tool body.

A cutting fluid filtering device which is controlled by a controller (not illustrated) is operated, the filter pump 111 is driven so as to pump the cutting fluid 119 including chips through the pipe line 120, and the cutting fluid filtered by the filter is supplied to the machine tool body 170 through the filter container 113. A filter (not illustrated) for filtering chips from the cutting fluid including the chips is attached to the inside of the filter container 113.

When the cutting fluid 119 including chips and stored inside the machining fluid tank 110 is continuously purified, the amount of the chips adhering to the filter inside the filter container 113 gradually increases. For this reason, the differential pressure between the inlet side pipe line 121 and the outlet side pipe line 122 increases. When the differential pressure between the inlet side pipe line 121 and the outlet side pipe line 122 becomes a predetermined value or more, the differential pressure switch 114 is operated so as to start the backwashing operation.

In the backwashing operation, first, the driving of the filter pump 111 is stopped so as to stop the pumping of the cutting fluid 119 including chips and stored in the machining fluid tank 110, and the inlet side pipe line 121 and the outlet side pipe line 122 of the filter container 113 are respectively closed by the inlet side valve 112 and the outlet side valve 118. Accordingly, the cutting fluid remaining in the filter container 113 can not flow into the machining fluid tank 110 and the machine tool body 170 any more.

Subsequently, the air supply valve 117 connected to the air source 116 is opened so as to supply the compressed air in a direction opposite to the flow direction of the cutting fluid 119, used for the normal purpose, into the filter container 113. Then, the air supply valve 117 connected to the air source 116 is closed and the discharge valve 115 connected to the filter container 113 is opened, so that the cutting fluid 119 which is pressurized by the compressed air from the air source 116 passes through the filter inside the filter container 113 in a direction opposite to the flow direction of the cutting fluid 119 used for the normal purpose and passes through the discharge valve 115 provided in the pipe line 123 so as to be returned into the machining fluid tank 110. The chips and the sludge adhering to the filter are removed by the flow of the cutting fluid 119.

In the backwashing operation performed by the conventional art described by referring to FIG. 8, the differential pressure switch 114 attached to the filter container 113 accommodating the filter for removing chips is operated to output a signal when detecting a predetermined pressure or more, and the backwashing operation is performed when the signal is output from the differential pressure switch 114. Further, it is described that a pressure sensor may be used instead of the differential pressure switch 114. However, any of these prior art documents does not disclose a method of improving the efficiency of removing chips during the backwashing operation.

Further, as a method of improving the efficiency of removing chips during the backwashing operation, Japanese Utility Model Application Laid-Open No. 60-104212 discloses a filter device in which a uniform pressure is applied to the entire periphery of a filter during the backwashing operation so as to effectively remove foreign matter of the entire surface of the filter. However, this prior art document discloses a method of improving the efficiency of removing chips during the backwashing operation, but does not disclose a method of changing the timing of operating respective units during the backwashing operation.

Further, Japanese Patent Application Laid-Open No. 62-201620 discloses a technique of controlling the inflow of compressed air using an opening and closing valve in a backwashing device of a filtering device. However, this prior art document just discloses that the timing of opening and closing an opening and closing valve provided in a water feeding pipe and the timing of opening and closing an opening and closing valve provided in an air feeding pipe may be adjusted by a controller. Specifically, it describes only that the opening and closing valve provided in the water feeding pipe and the opening and closing valve provided in the air feeding pipe are opened and closed at the same timing.

In all the above-described prior art documents, there is no consideration on the timing of opening the discharge pipe line after the compressed air is supplied into the filter in order to perform the backwashing operation. For this reason, a method of effectively using the pressure of the compressed air is not disclosed. In particular, the effect of removing chips grown into the filter is not sufficient.

### SUMMARY OF THE INVENTION

Therefore, it is an object of the invention to provide a machine tool equipped with a cutting fluid filtering device having a filter washing function of improving an effect of backwashing a filter by a method of backwashing a filter used to remove chips and sludge in a machine tool.

A machine tool of the invention is equipped with a cutting fluid filtering device, wherein the cutting fluid filtering device includes a filter container equipped with an inlet, an opening, and an outlet and having a filter accommodated therein and causes a cutting fluid including impurities to be supplied from the inlet into the filter container and to flow out of the opening so that the impurities are filtered by the filter, and wherein the cutting fluid filtering device has a filter washing function of removing the impurities adhering to the filter from the filter in a manner such that compressed air or the cutting fluid is supplied from the opening into the filter container and a valve provided in the outlet is opened so that the compressed air or the cutting fluid supplied to the filter container is discharged from the outlet.

The cutting fluid filtering device of a first embodiment includes a setting unit which sets a time taken until the valve provided in the outlet of the filter container is opened after the supply of the compressed air or the cutting fluid to the filter container starts, a timekeeping unit which counts a time from the start of the supply of the compressed air or the cutting fluid to the filter container, and an impurities discharging unit which opens the valve provided in the outlet of the filter container after the setting time set by the setting unit is counted by the timekeeping unit.

In the cutting fluid filtering device of the first embodiment, since the time of opening the valve provided in the container after the supply of the compressed air or the cutting fluid starts is set so that the valve is opened after the setting time elapses, the pressure of the compressed air or the cutting fluid may be sufficiently applied to the filter compared to a case where the valve provided in the container is opened from the early timing, and hence chips and sludge grown into the filter may be effectively removed.

The cutting fluid filtering device of a second embodiment includes a pressure detecting device which detects a pressure inside the filter or a pressure inside the filter container and feeds back the pressure to a controller and an impurities discharging unit which opens the valve provided in the outlet of the filter container when the pressure detected by the pressure detecting device becomes substantially equal to the supply pressure of the compressed air or the cutting fluid.

In the cutting fluid filtering device of the second embodiment, since the pressure detecting device is provided which detects the pressure inside the filter or the pressure inside the container and feeds back the pressure to the controller and the valve provided in the container is opened when the pressure detected by the pressure detecting device becomes substantially equal to the supply pressure of the compressed air or the cutting fluid, the valve provided in the container is opened after the pressure inside the filter or the pressure inside the container sufficiently increases. Accordingly, the pressure of the compressed air or the cutting fluid may be sufficiently applied to the filter, and hence chips and sludge grown into the filter may be also effectively removed.

With the invention, it is possible to provide a machine tool having a filter washing function of improving an effect of backwashing a filter by a method of backwashing a filter used to remove chips and sludge in a machine tool.

### BRIEF DESCRIPTION OF THE DRAWINGS

The object and the characteristic of the invention will become clear from the following embodiments with reference to the accompanying drawings. In these drawings:

FIG. 1 is a diagram illustrating a first embodiment of a cutting fluid filtering device according to the invention;

FIG. 2 is a flowchart illustrating an example of a backwashing operation using the cutting fluid filtering device of FIG. 1;

FIG. 3 is an example of a timing chart illustrating an operation of the cutting fluid filtering device of FIG. 1;

FIG. 4 is a diagram illustrating a second embodiment of a cutting fluid filtering device according to the invention.

FIG. 5 is a flowchart illustrating an example of a backwashing operation using the cutting fluid filtering device of FIG. 4;

FIG. 6 is a diagram illustrating a third embodiment of a cutting fluid filtering device of the invention;

FIG. 7 is a flowchart illustrating an example of (a part of) a backwashing operation using the cutting fluid filtering device of FIG. 6; and

FIG. 8 is a diagram illustrating a conventional cutting fluid filtering device.

### DETAILED DESCRIPTION OF THE PREFERRED EMBODIMENTS

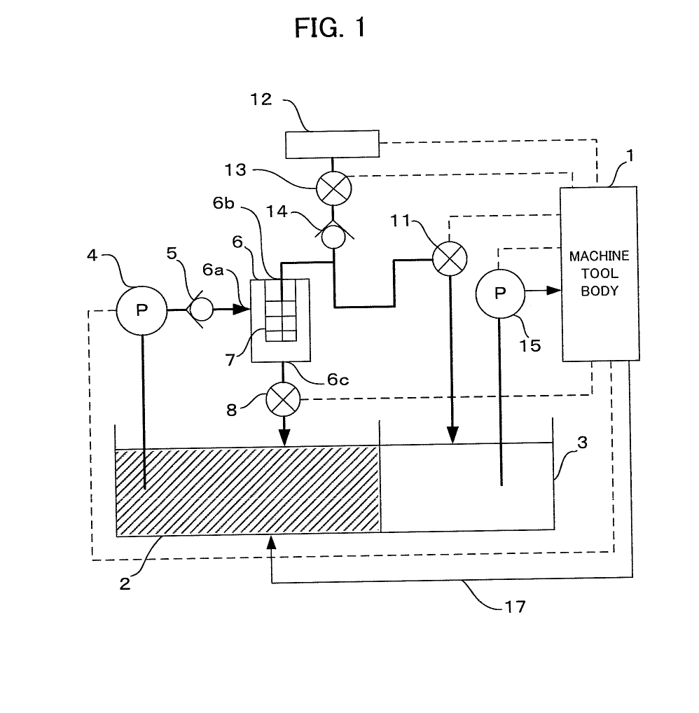

First, a first embodiment of a cutting fluid filtering device will be described by referring to FIG. 1.

Reference Numeral 1 indicates a machine tool body including a controller, Reference Numeral 2 indicates a sewage tank, Reference Numeral 3 indicates a freshwater tank, Reference Numeral 4 indicates a filter pump, Reference Numeral 5 indicates a check valve provided at the rear side of the filter pump when viewed from the flow of the cutting fluid, and Reference Numeral 6 indicates a filter container. The filter container 6 is equipped with an inlet 6a into which a cutting fluid flows from the filter pump 4, an opening 6b through which a cutting fluid flows to the outside during a filtering operation and air flows from the outside during a backwashing operation, and an outlet 6c from which air or a cutting fluid is discharged during a backwashing operation, and a filter 7 is provided inside the filter container 6. Further, Reference Numeral 8 indicates a backwashing discharge valve, Reference Numeral 11 indicates a freshwater tank valve, Reference Numeral 12 indicates an air source, Reference Numeral 13 indicates an air supply valve, Reference Numeral 14 indicates a check valve provided at the downstream side of the air supply valve 13 when viewed from the flow of the air from the air source, and Reference Numeral 15 indicates a cutting fluid supply pump.

The machine tool body 1 is controlled by a controller (not illustrated) therein so that a workpiece (not illustrated) is machined. Further, the controller also controls the cutting fluid supply pump 15 so that the cutting fluid supply pump 15 supplies the cutting fluid filtered and stored in the freshwater tank 3 to the machine tool body 1. The cutting fluid is used to machine the workpiece, and is collected to the sewage tank 2 through a pipe line 17.

The controller inside the machine tool body 1 also performs the driving control of the filter pump 4 and the air source 12 and the opening and closing control of the backwashing discharge valve 8, the freshwater tank valve 11, and the air supply valve 13 as indicated by the dotted line of FIG. 1 in addition to the control of the machine tool body 1 and the cutting fluid supply pump 15.

First, an operation of filtering the cutting fluid including impurities produced by the processing using the machine tool will be described.

The machining fluid tank includes the sewage tank 2 and the freshwater tank 3. The sewage tank 2 stores the cutting fluid collected from the machine tool body 1, and the cutting fluid is mixed with impurities such as chips and sludge. The filter pump 4 pumps the cutting fluid including impurities and stored in the sewage tank 2 and supplies the cutting fluid into the filter container 6 through the inlet 6a. The inside of the filter container 6 is equipped with the filter 7 which removes impurities such as chips and sludge mixed with the cutting fluid. Further, the check valve 5 is provided between the filter pump 4 and the filter container 6 so as to prevent the reverse flow of the cutting fluid from the filter container 6 and the compressed air (to be described later) toward the filter pump 4. Moreover, the backwashing discharge valve 8 is provided between the outlet 6c of the filter container 6 and the sewage tank 2. Further, the freshwater tank valve 11 is provided between the outlet 6c of the filter container 6 and the freshwater tank 3.

In a case where the cutting fluid including impurities is filtered, the controller performs a control so that the freshwater tank valve 11 is opened, the backwashing discharge valve 8 is closed, and the air supply valve 13 is closed. Then, the cutting fluid is pumped from the sewage tank 2 by the filter pump 4, is supplied from the check valve 5 to the filter container 6 (filter 7) through the inlet 6a so that impurities such as chips and sludge are removed from the filter 7, and is discharged from the freshwater tank valve 11 to the freshwater tank 3 through the opening 6b. Furthermore, since the flow of the cutting fluid of the filter 7 inside the filter container 6 is the same as that the conventional configuration, the description thereof will not be repeated.

The freshwater tank 3 is equipped with a fluid level detecting sensor (not illustrated). When the fluid level decreases in height, the filter pump 4 is operated so as to filter the cutting fluid by the filter, and the cutting fluid is supplied to the freshwater tank 3.

The filter 7 which is provided inside the filter container 6 so as to remove impurities such as chips and sludge may undergo a washing operation of removing chips and sludge adhering to the filter 7 in order to keep the performance of the filter or extend the lifetime thereof. As an example of an operation of washing the filter 7, a backwashing operation is known. Therefore, the backwashing operation will be described by referring to FIG. 1.

The freshwater tank valve 11 which is positioned at the outlet side of the filter container 6 attached with the filter 7 to be subjected to the backwashing operation is closed, so that the cutting fluid remaining inside the filter container 6 does not move. The flow from the filter container 6 to the filter pump 4 through the inlet 6a is interrupted by the check valve 5. Then, the air supply valve 13 connected to the air source 12 is opened so that the compressed air is supplied into the filter container 6 through the opening 6b while passing through the check valve 14 in a direction opposite to the normal cutting fluid flow direction and the backwashing discharge valve 8 is opened. Therefore, the cutting fluid which is pressurized by the compressed air from the air source 12 passes through the filter container 6 in a direction opposite to the normal cutting fluid flow direction. Then, the cutting fluid is discharged from the outlet 6c and passes through the backwashing discharge valve 8 so as to be returned to the sewage tank 2. By the flow of the cutting fluid, impurities such as chips and sludge adhering to the filter 7 may be removed.

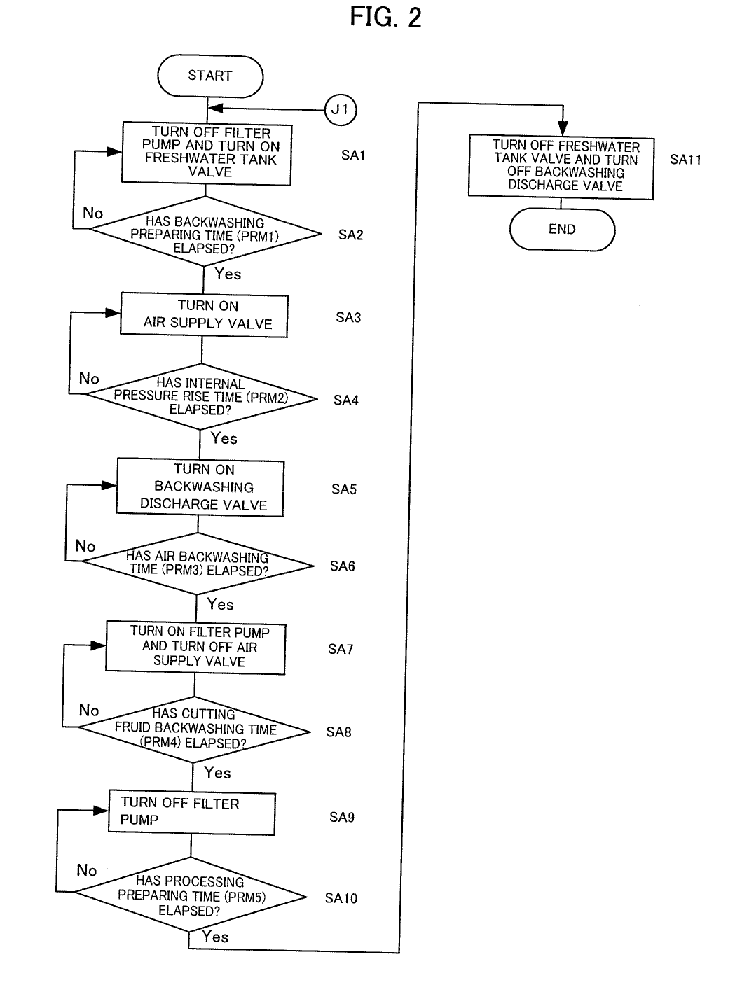

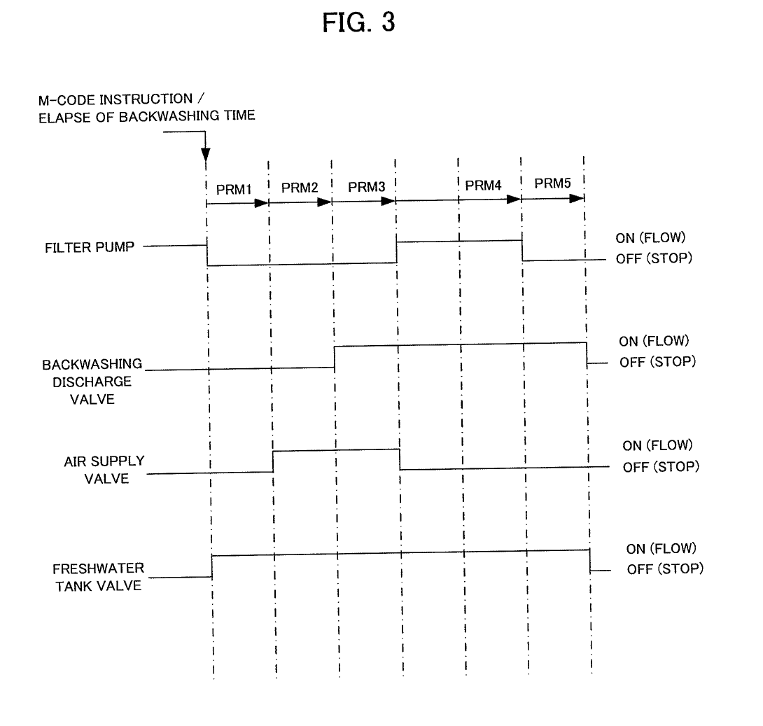

Incidentally, when the cutting fluid filtering device of FIG. 1 performs the backwashing operation, the cutting fluid filtering device performs an operation of supplying the compressed air from the air source 12 into the filter 7 and an operation of opening the discharge pipe line from the filter container 6. Here, a control is performed which keeps a predetermined time interval between both operations until the pressure inside the filter 7 (or inside the filter 7 and inside the filter container 6) becomes equal to the compressed air supply pressure and then opens the discharge pipe line. The specific operation will be described based on FIGS. 2 and 3.

FIG. 2 is a flowchart illustrating an example of a backwashing operation using the cutting fluid filtering device of FIG. 1, and FIG. 3 is an example of a timing chart illustrating an operation of the cutting fluid filtering device of FIG. 1.

First, a time is obtained in advance which is taken until the pressure inside the filter 7 (or inside the filter 7 and inside the filter container 6) becomes equal to the compressed air supply pressure after the supply of the compressed air from the air source 12 toward the filter 7 starts, and the obtained time is set as an internal pressure rise time (PRM2) (to be described later) in the controller inside the machine tool body 1. Since the setting time is different depending on the machine installation environment or the use condition, it is desirable to set the setting time as a value that may be changed in response to the machine installation environment or the use condition.

Hereinafter, the sequence of the process of the backwashing operation performed by the cutting fluid filtering device of FIG. 1 will be described by using the flowchart of FIG. 2 while referring to the timing chart of FIG. 3.

[Step SA1] First, the filter pump 4 is turned off so as to stop the supply of the cutting fluid, and the freshwater tank valve 11 is closed. Accordingly, the inflow and the outflow of the cutting fluid with respect to the filter container 6 are stopped, and this state is kept until the backwashing air is supplied. Further, a timekeeping operation of a timer (timekeeping unit) is started.

[Step SA2] It is determined whether a predetermined backwashing preparing time (PRM1) elapses or not. When the time does not elapse (No), the process returns to step SA1. On the other hand, when the time elapses (Yes), the process proceeds to step SA3.

[Step SA3] The air supply valve 13 is turned on so as to supply the air from the air source 12 to the filter 7 and the filter container 6. At this time, since the check valve 5, the backwashing discharge valve 8, the freshwater tank valve 11 are all closed, the pressure inside the filter 7 (or inside the filter 7 and inside the filter container 6) may be increased by the air supplied from the air source 12.

[Step SA4] It is determined whether the internal pressure rise time (PRM2) which is obtained and set in advance elapses or not. When the time does not elapse (No), the process returns to step SA3. On the other hand, when the time elapses (Yes), it is determined that the pressure inside the filter 7 (or inside the filter 7 and inside the filter container 6) is substantially equal to the compressed air supply pressure, and the process proceeds to step SA5.

[Step SA5] The backwashing discharge valve 8 is turned on so that the air flows. Accordingly, the filter 7 is backwashed by the air supplied from the air source 12.

[Step SA6] It is determined whether a predetermined air backwashing time (PRM3) elapses. When the time does not elapse (No), the process returns to step SA5. On the other hand, when the time elapses (Yes), the process proceeds to step SA7. [Step SA7] The filter pump 4 is turned on so as to start the supply of the cutting fluid. Also, the air supply valve 13 is closed so as to stop the supply of the air from the air source 12. Accordingly, the filter 7 is washed by the cutting fluid supplied from the filter pump 4 instead of the air.

[Step SA8] It is determined whether a predetermined cutting fluid backwashing time (PRM4) elapses or not. When the time does not elapse (No), the process returns to step SA7. On the other hand, when the time elapses (Yes), the process proceeds to step SA9.

[Step SA9] The filter pump 4 is turned off so as to stop the supply of the cutting fluid. Accordingly, since the backwashing discharge valve 8 is opened although the supply of the cutting fluid is stopped, chips and the cutting fluid inside the filter container 6 are removed.

[Step SA10] It is determined whether a predetermined processing preparing time (PRM5) elapses or not. When the time does not elapse (No), the process returns to step SA9. On the other hand, when the time elapses (Yes), the process proceeds to step SA11.

[Step SA11] The backwashing discharge valve 8 is turned off so that the air and the cutting fluid do not flow. Also, the freshwater tank valve 11 is turned off so that the cutting fluid flows. This process is ended in a state where the cutting fluid can be supplied from the sewage tank 2 to the freshwater tank 3.

Furthermore, in the cutting fluid filtering device of the first embodiment, the internal pressure rise time (PRM2) is set as the time in which the pressure inside the filter 7 and inside the filter container 6 becomes equal to the compressed air supply pressure from the air source 12. However, when a difference between the pressure inside the filter 7 and inside the filter container 6 and the compressed air supply pressure from the air source 12 falls within a certain allowable range even when the difference is slightly large, the backwashing discharge valve 8 may be turned on by determining that the internal pressure rise time (PRM2) elapses at the time point.

The controller inside the machine tool body 1 illustrated in FIG. 1 includes the setting unit which sets the time taken until the backwashing discharge valve 8 provided in the outlet 6c of the filter container 6 is opened after the supply of the compressed air or the cutting fluid to the filter container 6 starts, the timer (timekeeping unit) which counts the time from the start of the supply of the compressed air or the cutting fluid to the filter container 6, and the impurities discharging unit which opens the backwashing discharge valve 8 provided in the outlet 6c of the filter container 6 after the timer counts the setting time set by the setting unit.

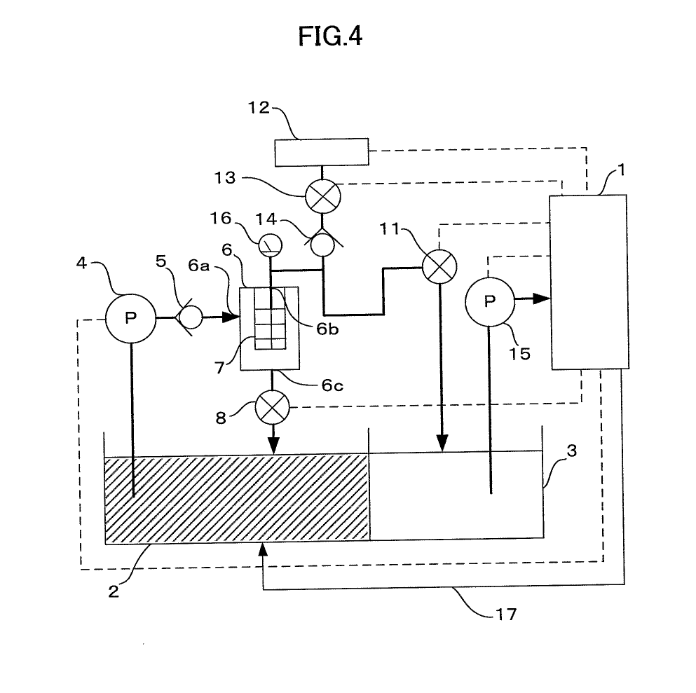

Next, a second embodiment of the cutting fluid filtering device will be described by referring to FIG. 4.

The same reference numerals will be given to the corresponding components of the cutting fluid filtering device of the second embodiment as those of the cutting fluid filtering device of the first embodiment described by referring to FIG. 1. As illustrated in FIG. 4, the cutting fluid filtering device of the second embodiment is different from the cutting fluid filtering device of the first embodiment in that the pipe line between the filter container 6 and the freshwater tank valve 11 is equipped with a pressure gauge 16 which detects the pressure inside the filter 7 or the pressure inside the filter 7 and inside the filter container 6.

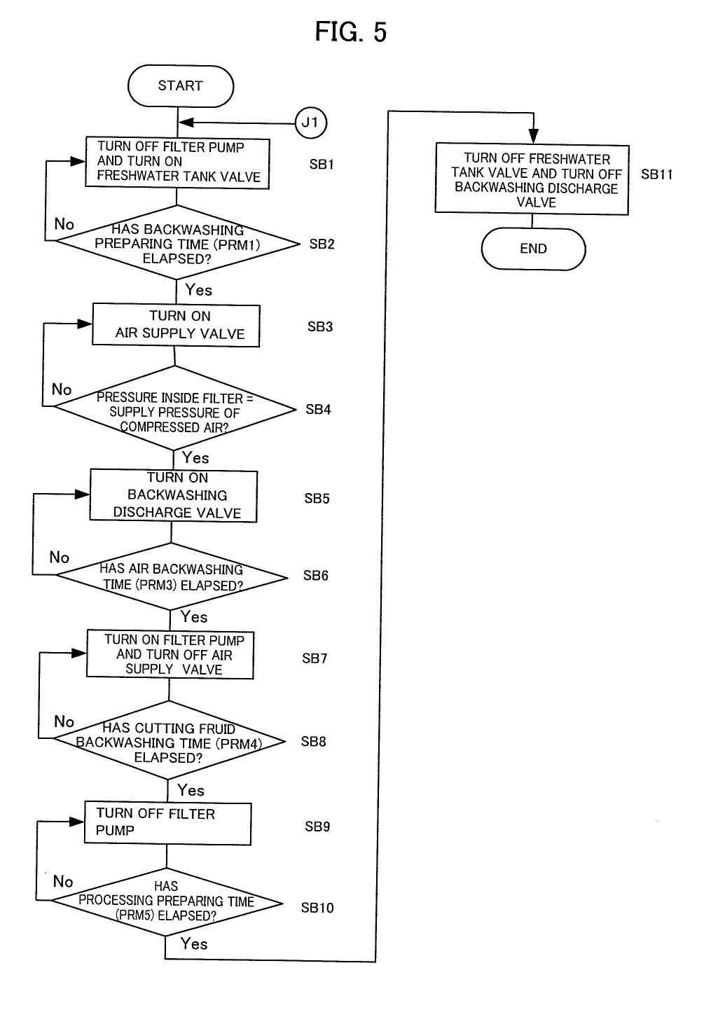

In the cutting fluid filtering device of the second embodiment, a control is performed when performing the backwashing operation so that the pressure inside the filter 7 or the pressure inside the filter 7 and inside the filter container 6 is detected by the pressure gauge 16 and the discharge pipe line is opened after the pressure becomes equal to the compressed air supply pressure from the air source 12. Therefore, the sequence of the process of the backwashing operation performed by the cutting fluid filtering device of the second embodiment will be described by referring to the flowchart of FIG. 5. Hereinafter, each step of the flowchart of FIG. 5 will be described.

[Step SB1] This step is the same as step SA1 of the flowchart of FIG. 2.

[Step SB2] This step is the same as step SA2 of the flowchart of FIG. 2. [Step SB3] This step is the same as step SA3 of the flowchart of FIG. 2.

[Step SB4] It is determined whether or not the pressure inside the filter 7 or the pressure inside the filter 7 and inside the filter container 6 becomes equal to the compressed air supply pressure from the air source 12. When both pressures are not equal to each other (No), the process returns to step SB3. On the other hand, when both pressures are equal to each other, the process proceeds to step SB5.

[Step SB5] This step is the same as step SA5 of the flowchart of FIG. 2.

[Step SB6] This step is the same as step SA6 of the flowchart of FIG. 2.

[Step SB7] This step is the same as step SA7 of the flowchart of FIG. 2.

[Step SB8] This step is the same as step SA8 of the flowchart of FIG. 2.

[Step SB9] This step is the same as step SA9 of the flowchart of FIG. 2.

[Step SB10] This step is the same as step SA10 of the flowchart of FIG. 2

[Step SB11] This step is the same as step SA11 of the flowchart of FIG. 2.

Furthermore, in the filter washing device of the second embodiment, it is determined whether or not the pressure inside the filter 7 or the pressure inside the filter 7 and inside the filter container 6 becomes equal to the compressed air supply pressure from the air source 12 in step SB4. However, when a difference between the pressure inside the filter 7 (or the pressure inside the filter 7 and inside the filter container 6) and the compressed air supply pressure from the air source 12 falls within a certain allowable range when the difference is slightly large, the backwashing discharge valve 8 may be turned on before the pressure inside the filter 7 (or the pressure inside the filter 7 and inside the filter container 6) becomes equal to the compressed air supply pressure from the air source 12.

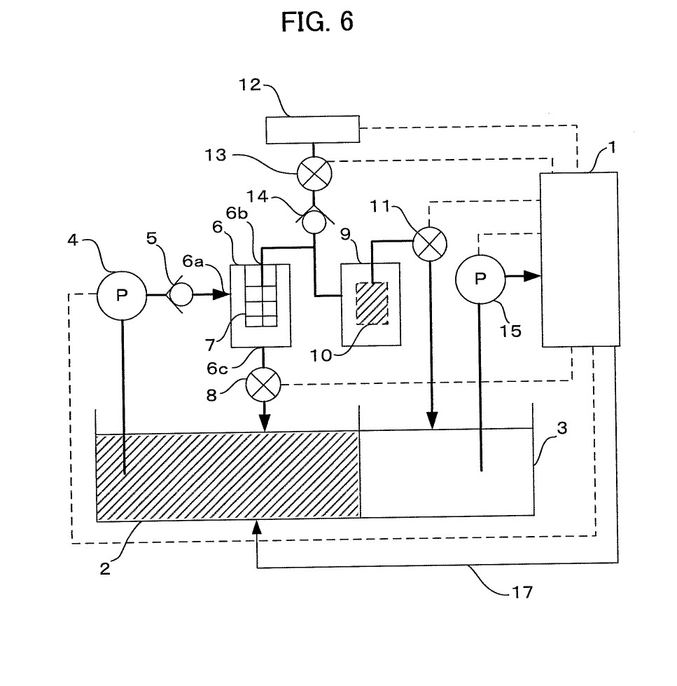

Next, a third embodiment of a cutting fluid filtering device will be described by referring to FIG. 6.

The same reference numerals will be given to the corresponding components of the cutting fluid filtering device of the third embodiment as those of the cutting fluid filtering device of the first embodiment described by referring to FIG. 1. As illustrated in FIG. 6, the cutting fluid filtering device of the third embodiment is different from the cutting fluid filtering device of the first embodiment in that a line filter container 9 provided inside the line filter 10 is provided between the filter container 6 and the freshwater tank valve 11.

A filter having openings smaller than those of the filter 7 is used in the line filter 10, and the cutting fluid is supplied to the line filter so that the cutting fluid filtered by the filter 7 is filtered by the line filter 10 having smaller openings. Accordingly, it is possible to improve the performance of filtering the cutting fluid supplied to the freshwater tank 3.

Furthermore, the cutting fluid filtering device of the third embodiment illustrated in FIG. 6 has a structure in which the line filter container 9 and the line filter 10 are provided between the freshwater tank valve 11 and the filter container 6 of the cutting fluid filtering device of the first embodiment illustrated in FIG. 1. However, the cutting fluid filtering device of the third embodiment may have a structure in which the line filter container 9 and the line filter 10 are provided between the freshwater tank valve 11 and the filter container 6 of the cutting fluid filtering device of the second embodiment illustrated in FIG. 4.

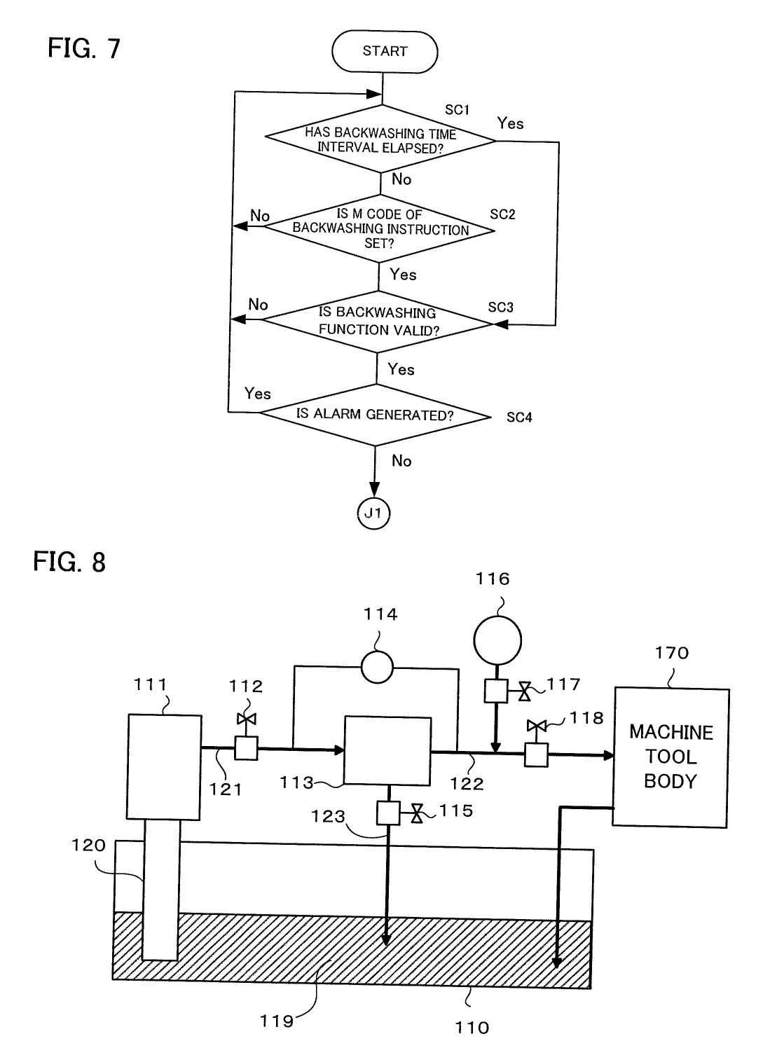

The sequence of the process of the backwashing operation performed by the cutting fluid filtering device of the third embodiment illustrated in FIG. 6 will be described by referring to the flowchart of FIG. 7. In the process of the backwashing operation performed by the cutting fluid filtering device of the third embodiment, a process of checking the backwashing function or forcedly performing the backwashing operation is additionally provided before the backwashing operation performed by the cutting fluid filtering device of the first and second embodiments. Hereinafter, each step of the flowchart of FIG. 7 will be described.

[Step SC1] First, it is determined whether or not a predetermined backwashing time interval elapses from the precedent backwashing operation. When the time elapses (Yes), the process proceeds to step SC3. On the other hand, when the time does not elapse (No), the process proceeds to step SC2.

[Step SC2] It is determined whether an M code for forcedly instructing the backwashing operation is set or not. When the M code is set (Yes), the process proceeds to step SC3. On the other hand, when the M code is not set (No), the process returns to step SC1.

[Step SC3] It is determined whether the backwashing function is valid. Specifically, when the backwashing function is not valid, this valid state is determined by a flag or a check bit. When the backwashing function is valid (Yes), the process proceeds to step SC4. On the other hand, when the backwashing function is not valid (No), the process returns to step SC1.

[Step SC4] It is determined whether an alarm for notifying the problem of the backwashing function is generated or not. When the alarm is generated (Yes), the process returns to step SC1. On the other hand, when the alarm is not generated (No), the process proceeds to step SA1 of the flowchart of FIG. 2 so as to perform the process of the flowchart or the process proceeds to step SB1 of the flowchart of FIG. 5 so as to perform the process of the flowchart.

In the cutting fluid filtering device mentioned in the first, second, and third embodiments, since the discharge pipe line is opened after the compressed air supply pressure becomes equal to the pressure inside the filter 7 (or the pressure inside the filter 7 and inside the filter container 6), the compressed air supply pressure is sufficiently applied to the filter 7, so that the filter is pressed by the inflow of the compressed air thereto. Accordingly, the flow velocity and the pressure of the cutting fluid flowing from the inside of the filter 7 to the outside become maximal, and hence the effect of removing chips adhering to the surface of the filter 7 can be improved.

Furthermore, in the cutting fluid filtering device of the embodiments, the backwashing operation is performed by using the compressed air from the air source at the first half of the backwashing operation, and the backwashing operation is performed by using the fluid at the second half of the backwashing operation. However, the backwashing operation may be performed by using the fluid instead of the compressed air even at the first half of the backwashing operation.

1. A machine tool equipped with a cutting fluid filtering device,
wherein the cutting fluid filtering device includes a filter container equipped with an inlet, an opening, and an outlet and having a filter accommodated therein and causes a cutting fluid including impurities to be supplied from the inlet into the filter container and to flow out of the opening so that the impurities are filtered by the filter,
wherein the cutting fluid filtering device has a filter washing function of removing the impurities filtered and adhering to the filter from the filter in a manner such that compressed air or the cutting fluid is supplied from the opening into the filter container and a valve provided in the outlet is opened so that the compressed air or the cutting fluid supplied to the filter container is discharged from the outlet, and
wherein the cutting fluid filtering device includes
a setting unit which sets a time taken until the valve provided in the outlet of the filter container is opened after the supply of the compressed air or the cutting fluid to the filter container starts,
a timekeeping unit which counts a time from the start of the supply of the compressed air or the cutting fluid to the filter container, and
an impurities discharging unit which opens the valve provided in the outlet of the filter container after the setting time set by the setting unit is counted by the timekeeping unit.

2. A machine tool equipped with a cutting fluid filtering device,
wherein the cutting fluid filtering device includes a filter container equipped with an inlet, an opening, and an outlet and having a filter accommodated therein and causes a cutting fluid including impurities to be supplied from the inlet into the filter container and to flow out of the opening so that the impurities are filtered by the filter,
wherein the cutting fluid filtering device has a filter washing function of removing the impurities filtered and adhering to the filter from the filter in a manner such that compressed air or the cutting fluid is supplied from the opening into the filter container and a valve provided in the outlet is opened so that the compressed air or the cutting fluid supplied to the filter container is discharged from the outlet, and
wherein the cutting fluid filtering device includes
a pressure detecting device which detects a pressure inside the filter or a pressure inside the filter container and feeds back the pressure to a controller, and
an impurities discharging unit which opens the valve provided in the outlet of the filter container when the pressure detected by the pressure detecting device becomes substantially equal to the supply pressure of the compressed air or the cutting fluid.
